(19) United States
(12) Patent Application Publication
(10) Pub. No.: US 2012/0191465 A1
(43) Pub. Date: Jul. 26, 2012

(54) SYSTEM AND METHOD FOR ANALYZING HOSPITAL DATA

(75) Inventors: Feng Xue, Clifton Park, NY (US); Richard L. Frowein, Waukesha, WI (US); Piero Patrone Bonissone, Schenectady, NY (US); Susan M. Quinion, Windham, NH (US); Melissa Jaroneski, Glen Allen, VA (US); Angela Neff Patterson, Blacksburg, VA (US); James Kenneth Aragones, Clifton Park, NY (US)

(73) Assignee: General Electric Company, Schenectady, NY (US)

(21) Appl. No.: 13/011,504

(22) Filed: Jan. 21, 2011

(51) Int. Cl. G06Q 50/00; G06Q 10/00

(52) U.S. Cl. 705/2

(57) ABSTRACT

The present disclosure relates approaches that may be used to analyze data from hospital records to identify deficiencies in the operation of the hospital. In certain implementations, features of the data may be evaluated in conjunction with performance indicators to identify root causes associated with the deficiencies. In further implementations, identification of root causes of deficiencies identified in the historical data may be used to generate recommendations for changes to the operation of the hospital. In further implementations, events may be predicted based on the identification of a features or features within the current data that is indicative of a pending problem or event.

### BACKGROUND OF THE INVENTION

The subject matter disclosed herein relates to the field of pattern recognition and, in particular, to the use of pattern recognition on data related to patient flow and utilization of facilities and/or equipment within a hospital.

Today's hospitals rely on a variety of healthcare information systems (HIS) that facilitate and/or coordinate the various functions of hospital operation. The use of such information systems throughout the entire hospital enterprise is typical in today's hospital operation. However, these information systems tend to be distinct and separate vendor systems that typically work in a stand-alone manner. As such these systems may be used for the purpose of easy information access, clinical support, and billing within a floor or care unit. However, these systems typically are not useful for evaluating the operational efficiency of individual units within the hospital or within the hospital at large. As hospitals focus more on productivity and cutting cost to deal with high volume and tightened reimbursements, it has become important for hospital administrators to know where the deficiencies are across the entire hospital and the causes of these operation deficiencies.

### BRIEF DESCRIPTION OF THE INVENTION

In one embodiment, a method is provided for identifying operational deficiencies at a hospital. The method includes the act of accessing one or more databases comprising a plurality of hospital records. A plurality of features are extracted from the hospital records and a performance indicator is derived that provides a measure of operational performance for the hospital. One or more root causes contributing to the derived performance indicator are identified.

In a further embodiment, one or more non-transitory computer-readable media are provided. The computer-readable media comprise one or more routines which, when executed by a processor, perform acts comprising: accessing a database comprising a plurality of hospital records wherein the hospital records comprise records describing the flow of patients through the hospital and records describing the scheduling of availability of one or more of hospital staff, hospital facilities, or hospital equipment; extracting a plurality of features from the hospital records, wherein the features comprise metrics that summarize aspects of the hospital records at different times; deriving a performance indicator that comprises a metric that represent an aspect of the operational performance of the hospital at different times; and identifying one or more root causes that comprise a feature or subset of features that contributes to the value of the performance indicator.

In an additional embodiment, a method is provided for generating recommendations or notifications for a hospital. The method includes the act of accessing one or more databases comprising a plurality of hospital records. An operational deficiency is identified or an event predicted using one or more features derived from the plurality of hospital records. A recommendation is generated based on the identified operational deficiency or the predicted event.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of a patient flow through a hospital, in accordance with aspects of the present disclosure;

FIG. 2 depicts an example of patient data records that may be generated for a patient in a hospital, in accordance with aspects of the present disclosure;

FIG. 3 depicts an example of administrative data records that may be generated for a facility or piece of equipment in a hospital, in accordance with aspects of the present disclosure;

FIG. 4 is a flowchart depicting steps by which root causes for operational deficiencies may be identified using hospital records, in accordance with aspects of the present disclosure;

FIG. 5 is a table depicting examples of features that may be derived from hospital records, in accordance with aspects of the present disclosure;

FIG. 6 is a table depicting examples of performance indicators that may be derived from hospital records, in accordance with aspects of the present disclosure;

FIG. 7 is a flow diagram depicting one approach to deriving root causes from historical hospital operation data, in accordance with aspects of the present disclosure;

FIG. 8 depicts a graphical example by which a performance indicator may be evaluated based on a single feature, in accordance with aspects of the present disclosure;

FIG. 9 is a flowchart depicting a closed-loop arrangement by which root cause information may be used to improve hospital operation, in accordance with aspects of the present disclosure; and

FIG. 10 is a flowchart depicting the use of an event prediction module improve near-term decision making in a hospital setting, in accordance with aspects of the present disclosure.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, each example or embodiment is provided to facilitate explanation of certain aspects of the invention and should not be interpreted as limiting the scope of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present disclosure covers such modifications and variations as come within the scope of the appended claims and their equivalents.

As noted above, hospitals may utilize a variety of separate and distinct healthcare information systems (HIS) that provide different functionality within the hospital (or a network of hospitals) or within different units of such hospitals. As a result of the use of such systems, hospitals may generate a variety of data (e.g., records) related to the steps of the care process as a patient moves through the hospital facility. Likewise, data may also be generated related to hospital resources (e.g., equipment, staff, doctors, and so forth). In some instances such patient, resource, and personnel data may even be tracked in real-time with positioning systems, such as based on card key readers, Radio Frequency Identification (RFID) tags, and so forth. Data may also be generated related to the various workflow steps along the care processes. As a result, a large volume of patient/resources movement data and workflow state data may be captured. As discussed herein, this patient movement and workflow data may be analyzed to identify deficiencies in hospital operation and/or discover root causes (i.e., contributing factors) of the operation deficiencies.

For example, in one embodiment, hospital care process data extracted from databases may be analyzed to quantify operation deficiency and discover root causes of operation deficiencies in hospital operation which may be used to address existing or long-term deficiencies. Based on the determined deficiencies and/or root causes, a control system (e.g., a closed-loop control system) may be utilized to generate recommended adjustments to hospital care processes, scheduling, staff planning, and so forth that can result in improved operation efficiency, service quality, and patient satisfaction. In certain implementations, hospital operation deficiencies may be quantified using derived key performance indictors (KPI), and the causal relationships of these KPIs may be examined as time dependent events. As a result, root causes of operation deficiencies may be identified.

Further, such analysis may be used to generate, update, or teach a prediction model that may be used to predict defined events in the hospital operation. For example, a prediction model, such as a decision tree, may be generated using features extracted from the hospital data and used to predict a defined event ahead of time. In this manner, near-term or imminent events that may impact hospital operation or efficiency may be predicted and pro-actively addressed.

With the foregoing in mind, and turning to the figures, various approaches for processing hospital information system data in accordance with the present disclosure are discussed. Patient interactions with a hospital may be varied, ranging from emergency room visits, radiological examinations, in- and out-patient surgeries, diagnostic testing and/or lab work, and so forth. The wide range of services offered by a hospital are typically spread between a variety of departments or units within the hospital, each of which may have a separate system or systems to manage patient interactions and work load. These varied systems may in turn generate separate and distinct data sets for use by the respective systems.

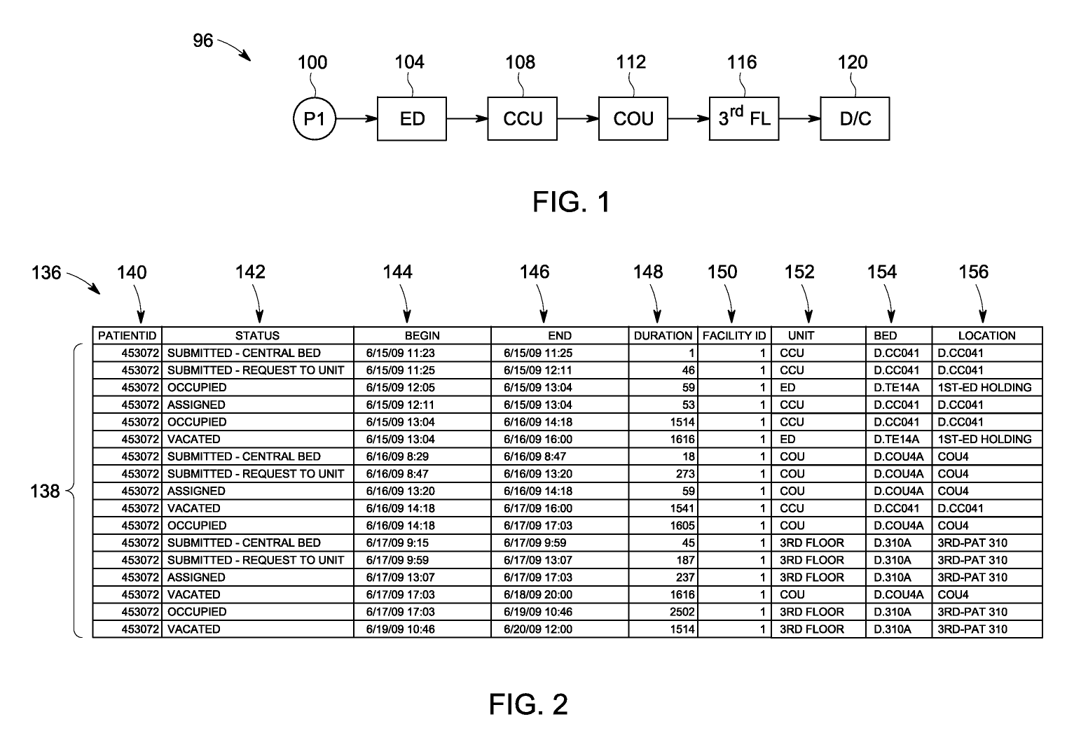

By way of example of how a sample patient visit might progress, FIG. 1 depicts a sample of an event sequence 96 of one patient 100 (e.g., patient P1) during a visit to the hospital. In this example of patient flow, the patient 100 initially arrives at the emergency department (ED) 104 with chest pains, is admitted to the coronary care unit (CCU) 108 for evaluation, and is later transferred to the close observation unit (COU) 112 for observation. Subsequently, the patient 100 is transferred to the 3rd floor unit 116 where he is later discharged 120.

Each step in this example of a patient event sequence 96 may correspond to a variety of different types of data being generated, often on separate and discrete systems that may utilize distinct and separate databases or formats. For example, each unit that the patient 100 is transferred to may utilize a separate system that specifically addresses the needs of that respective unit, such as the intake of patients into the emergency department and their initial evaluation, the observation and treatment of cardiac patients, and so forth. The patient data points associated with each treatment step may be entered by the service providers during the care process and/or may be entered in response to feedback from patient monitoring equipment.

Further, each transfer may be a variety of administrative steps that are associated with the transfer but are not typically patient specific. For example, a house cleaning and/or equipment restocking task may typically be associated with each patient transfer. Likewise, equipment such as bedside monitors may be moved from unit to unit with the patient in some instances. These cleaning, stocking, and equipment movements may also generate data in respective hospital information systems. Further, similar event sequences may exist or be constructed not just for patients but also for hospital facilities, assets, or equipment and/or for hospital personnel, such as doctors and staff.

In accordance with the present disclosure, these event sequences (e.g., patient flows) and related data may be may be extracted and aggregated from the different information systems and databases used by a hospital. In certain embodiments, an information management or retrieval system may be employed that can interface with the existing information systems and aggregate the patient flow data, as well as any other suitable data, in a single data repository from which the data can then be accessed and processed.

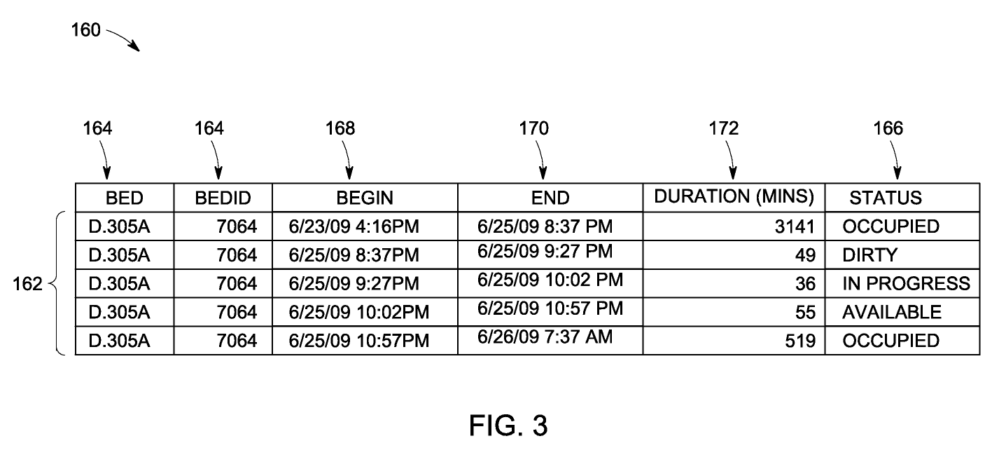

Examples of data that may be present in a hospital information system or database and which may be utilized in accordance with the present approach are depicted in FIGS. 2-3. In the first example, FIG. 2 depicts a data segment 136 from a database where the data segment 136 includes various records 138 that describe patient flow for a patient 100 through a hospital. In this example, the records 138 pertain to one patient (identified by a patient identifier 140) with each record 138 pertaining to a different status 142 of the patient 140. Each record 138 also includes the beginning time 144 and end time 146 for the respective status 142 and patient 140 as well as the respective duration 148 associated with the status 142, as measured in minutes. Additional information associated with the respective patient records 138 may include a facility identifier 150 (which may identify the hospital or institution where the patient 140 is located when records for multiple hospitals are present in the data) as well as a unit identifier 152 specifying the unit or department associated with the respective record 138. In the depicted example other information may be associated with each record, such as the respective bed 154 and location 156 where the patient 140 is located for the duration associated with the respective record status 142 may be present. Based on patient flow information of this type, detailed patient care process workflows can be generated, such as workflows that associate time stamps and/or durations with particular milestones in the care process (such as milestones for when the patient arrives for admission, and/or when the patient arrives at or departs from a particular unit, when the patient is released, and so forth.

While FIG. 2 depicts an example of a data segment associated with a patient, other databases or data segments may provide information related to hospital personnel, equipment, facilities and so forth (such as beds, imaging devices, ventilators, infusion pumps, and so forth). For example, turning to FIG. 3, an example of a data segment 160 associated with custodial or administrative information (here the status of a bed) is depicted. In this example, the records 162 pertain to one bed (identified by a bed identifier 164) with each record 162 pertaining to a different status 166 of the bed 164. Each record 138 also includes the beginning time 168 and end time 170 for the respective status 166 and bed 164 as well as the respective duration 172 associated with the status 166, as measured in minutes.

While the preceding depicts various examples of the types of data that may be present in various types of hospital information systems, it should be appreciated that other types of data, records, and data segments may also be available in a hospital information system and may be utilized in accordance with the present approaches. Thus, the examples of data and records described herein are provided for the purpose of explanation only and are not intended to limit or circumscribe the types of data or records that may be utilized in the analyses described herein. Indeed, any suitable type of hospital record or data may be used in the analyses described herein to evaluate efficiency and/or model or predict potential problems.

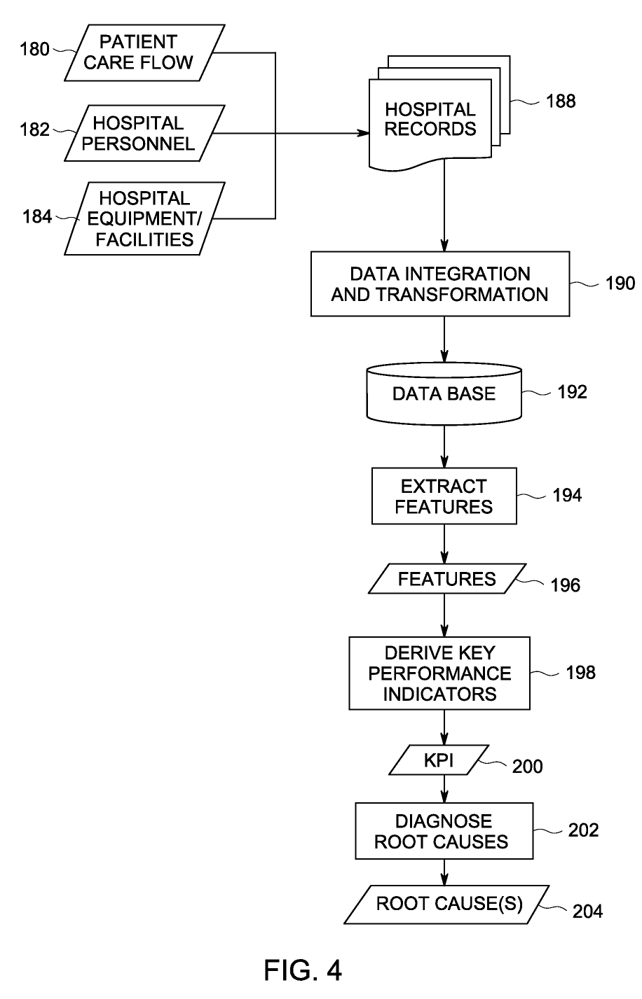

With this in mind and turning now to FIG. 4, one embodiment of a data flow in accordance with the present disclosure is depicted. In this example, patient flow data 180, personnel data 182, and/or equipment/facilities data 184 is generated during normal operations at a facility or hospital. Such data may take the form of one or more records 188 generated by and/or stored in one or more hospital information systems. The records 188 may be generated in response to various inputs to the respective hospital information systems, such as inputs coded or formatted in accordance with the HL7 standard for interoperability of health information technology. These various inputs or records 188 may be integrated and/or transformed (block 190) to allow data to be aggregated in one or more databases 192 from which the data may be subsequently accessed and processed.

In the depicted embodiment, one or more features 196 are extracted (block 194) from the raw data stored in the one or more databases 192. As used herein, features represent measures or metrics that summarize portions of the collected raw data, such as to provide one or more historical measures of the feature at different times. Some of the features 196 may be transformed based on the raw data over a selected time window. Thus, a feature is a summary statistic that may provide a snapshot of the state of the hospital, as measured for certain parameters, at one or more prior times. The extracted features 196 can characterize the operation of the hospital (or other facility) at any moment in time. For example, census data can be derived for each individual unit of the hospital; length of stay (LOS) data can be derived for each patient; and a variety of throughput delay metrics in the care process can be calculated; and so on. One example of a throughput delay metric is the time it takes from the initial request for a bed to the time when the patient is placed to the requested bed. In such an example, the raw data source captures when a bed request is made and when the patient is placed to a bed, fulfilling the bed request. From this data, the delay associated with this transfer step can be calculated to provide a measure (i.e., metric) of the corresponding throughput delay. Average or other derived values of such bed placement delays over a time window t may constitute one of the features 196 used to characterize hospital operation. In one implementation, some or all of the derived features 196 can be represented by a vector F₁=[fₜ¹, . . . , fₜ^{N}] to represent the hospital operation state at time t. Thus, features may form a multivariate time series that characterizes hospital operation states.

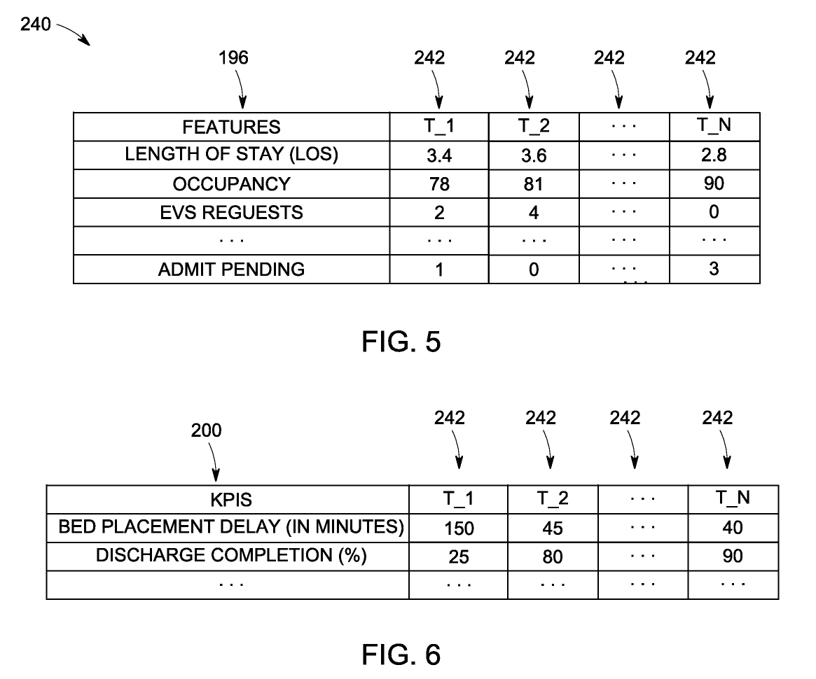

By way of example, examples of certain possible features 196 that may be calculated based on the raw data derived from the hospital information systems is depicted in FIG. 5. Also depicted in the table 240 of FIG. 5 are the values of the respective features 196 as calculated for respective times 242 t₁ through t_{N}. In this example, delay metrics (i.e., wait times or durations) are depicted for features 196 such as length of stay, occupancy, environmental services (EVS)/housekeeping requests, admits pending, and so forth.

The calculated features 196 and their corresponding values at different times may be used to derive (block 198) one or more key performance indicators 200. As used herein, the key performance indicators provide a tool that is derived to measure performance. For example, turning to FIG. 6, a sample of certain possible key performance indicators 200 is provided. As depicted, each key performance indicator 200 may have associated values that are derived for different times t 242, thus giving a measure of performance, as measured by that indicator, at the respective times 242. That is, key performance indicators may form a multivariate time series that characterizes hospital operation states.

For example, one such key performance indicator is discharge completion (measured as a percentage). In particular, as a unit in a hospital is tracking the number of discharges throughout a day, it may be useful to compare the number of discharge orders that has been issued so far and get a discharge completion rate and average delays at time t. Key performance indicators like this may be used to compare with the goal criteria set by the hospital. The comparison result can serve as indicators of hospital operation efficiency. Such goal criteria can be either set by benchmarking with industrial standards or calibrated using the hospital own historical operation patterns (such as the average or median discharge completion). The key performance indicators 200 can then be used to highlight hospital operation deficiency, when present.

Further, by applying the KPI concept to historical data or trends, we can obtain indications of when operation deficiencies have occurred based on the values of the derived key performance indicators a different time 242. For instance, in the depicted example bed placement delay is depicted as being unusually high (i.e., 150 minutes) at t₁ compared to other times t. Likewise, perhaps correspondingly, the discharge completion rate at t₁ is appears to be uncharacteristically low compared to other times t. Thus, one or more operational deficiencies may be determined to exist at time t₁. In certain embodiments a hospital may have goals or thresholds (such as based on historical trends or patterns) that may be used to determine when the value derived for a key performance indicator at a given time is indicative of an operational deficiency or s otherwise unacceptable. In other implementations, statistical measures (such as an average or median value along with the variance or standard deviation associated with a key performance indicator) may be used in evaluating whether a calculated value for a key performance indicator represents a minor or major deviation from expectations, i.e., normal operations.

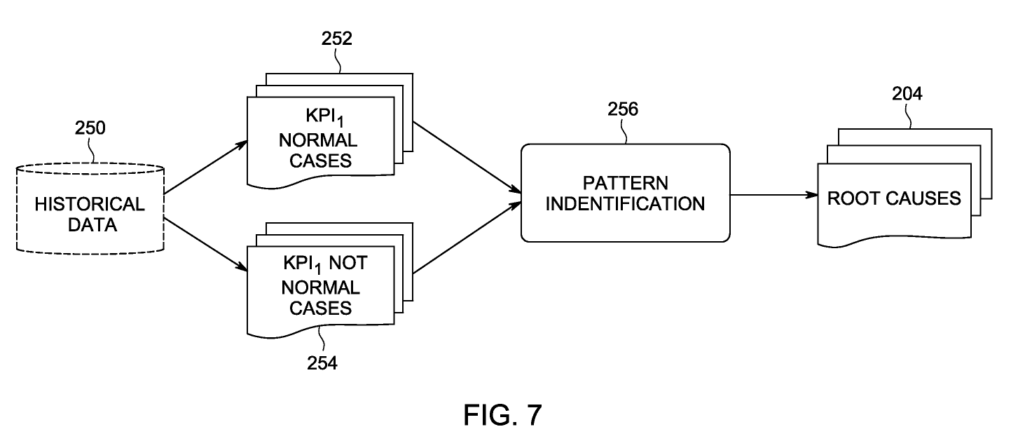

In addition, turning back to FIG. 4, one or more root causes 204 for operational deficiencies may be determined (block 202) when such operational deficiencies are identified. The root causes 204 typically represent systematic reasons that cause or result in the observed operational deficiency. For example, turning to FIG. 7, hospital historical operation data 250 may be analyzed to identify significant contributing factors to the occurrence of key performance indicators 200 that are outside expected or accepted bounds. In this example, the historical data 250 may be categorized into two classes of cases: the cases that are normal 252 (i.e., where the key performance indicator in question was within normal or accepted bounds) and the cases that are not normal 254 (i.e., where the key performance indicator in question was not within normal or accepted bounds). Each case typically contains multiple time series features 196. These features 196 can be summary values derived from the care process data over different time windows.

Once the historical data is divided into the normal cases 252 and not normal cases 254, pattern identification (block 256) can be utilized to identify patterns, circumstances, states, and so forth that explain when normal cases 252 occur and when not normal cases 254 occur. For example, in one implementation, pattern identification 256 may take the form of a feature selection approach that selects features 196 or subsets of features 196 that can be used to discriminate between the two classes of cases 252, 254. In such an example, the feature 196 or a subset of features 196 that have the most discriminant power may be associated with or describe the potential root cause 204 for the hospital operation deficiency associated with the unsatisfactory key performance indication 200.

One example of an implementation of feature selection to evaluate unsatisfactory key performance indications 200 is to use correlation analysis or single classifier classification. For example, in a single classifier classification implementation, each individual feature 196 is assessed individually (i.e., alone) to determine the suitability of the respective feature 196 as a classifier to distinguish the two classes 252, 254. A corresponding classification score for each feature 196 may then be used to rank the features 196. Based on this analysis, key contributing factors (e.g., root causes) may be identified that contribute to hospital deficiencies (i.e., underperforming key performance indicators 200).

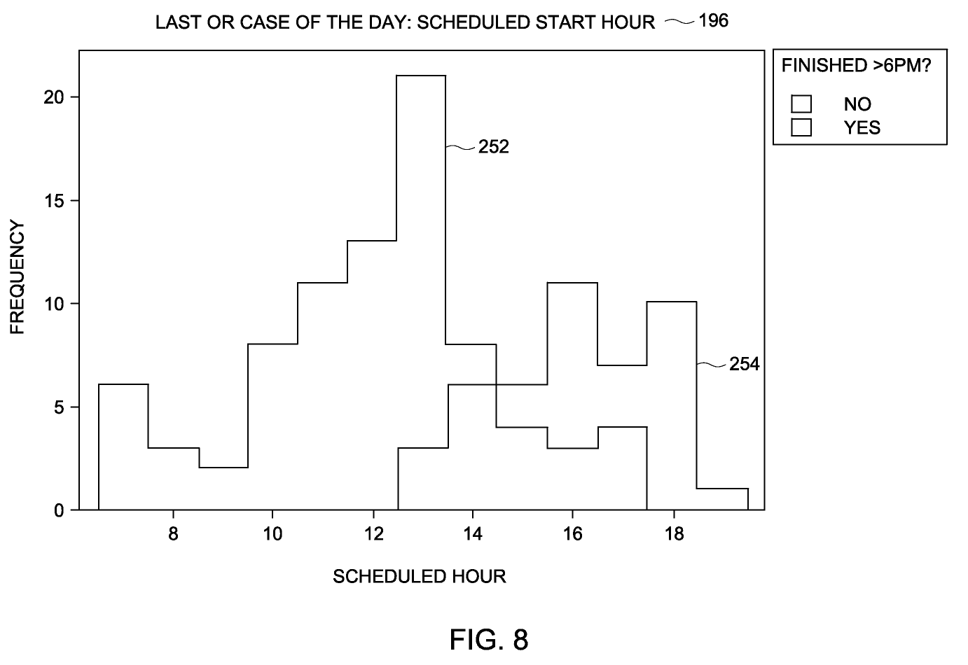

Turning to FIG. 8, an example of this approach is graphically depicted. In this example, the key performance indicator 200 relates to overtime, with the normal cases 252 corresponding to days without overtime (i.e., days finished before 6:00 PM) and the not normal cases 254 corresponding to days with overtime (i.e., days finished after 6:00 PM). In this example, the feature 196 being evaluated as a classifier is the scheduled start hour for the last case of the day. The effectiveness of this feature 196 alone in distinguishing between the normal and not normal cases 252, 254 (i.e., days in which there no overtime and days in which there is overtime) can be measured using classification error. In this example, the later the start time of the last case of the day, the greater the likelihood that the day will be a day with overtime. Thus, barring the presence of a feature with greater distinguishing power, it may be possible to determine that the scheduled start hour for the last case of the day is a root cause associated with days in which overtime is accrued.

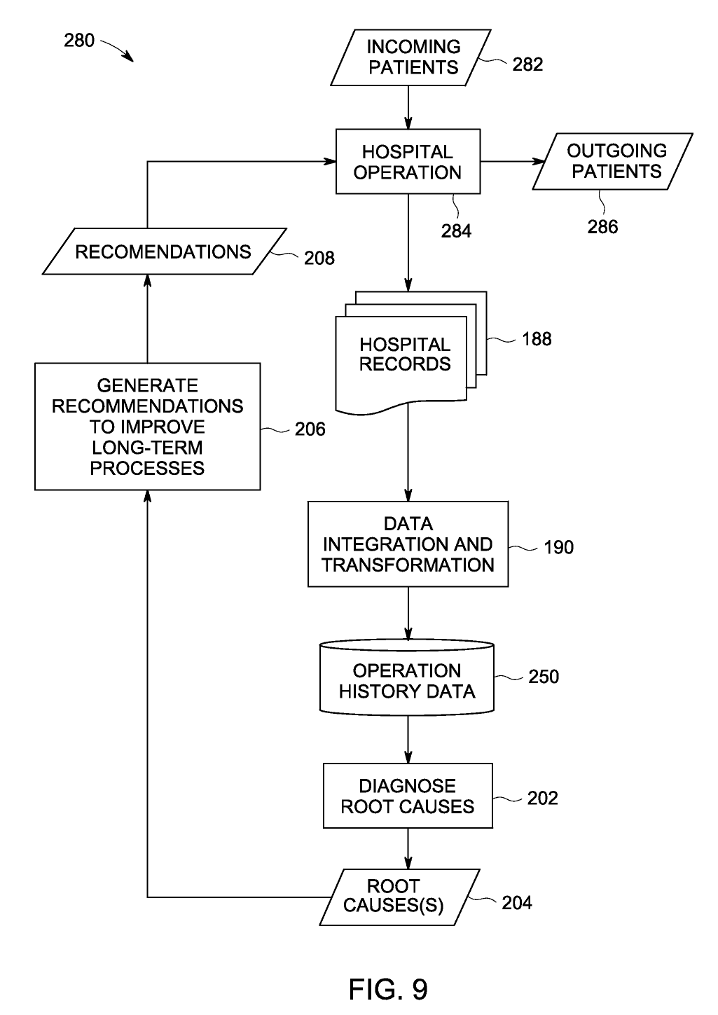

With the preceding in mind and turning to FIG. 9, an example of a closed-loop system (depicted in the context of flowchart 280) for leveraging such root cause information is depicted. In this example, incoming patients 282 are taken in and treated as part of the hospital operation 284, eventually being released as outgoing patients 286. As will be appreciated, the hospital operation 284 may include the treatment and/or observation of the patient (i.e., patient care flow) as well as encompassing the scheduling and activity of medical staff, administrative personnel, equipment, facilities, and any other hospital resource or personnel. As a consequence of the operation of the hospital, various hospital records 188 are generated which may be integrated and/or assimilated (block 190) and stored as historical data 250 of the operation of the hospital.

As discussed above, the historical hospital data 250 may be analyzed to identify operational deficiencies or inefficiency at the hospital, for which the various root causes 204 may be determined (block 202). Based on the root causes 204 of the identified inefficiencies, one or more recommendations 208 may be generated (block 206) for improving the long-term or existing processes at the hospital (such as long term scheduling and planning decisions). For example, the recommendations 208 may applied (such as by implementation of one or more rules, such as scheduling rules) so as to modify existing hospital operations 284, thereby addressing the inefficiencies identified in the historical hospital data 250. In certain embodiments, the recommendations 208 may be automatically derived and/or implemented. For example, one or more routines or algorithms may be automatically revised or modified based on the recommendations 208 to cause a change in how personnel are scheduled, how equipment is tracked or moved, /and/or how patients are sequenced. In other embodiments, the recommendations 208 may be implemented by one or more operators or decision makers, as opposed to being automatically implemented.

In the depicted implementation where feedback and process modification are in a closed-loop arrangement, the identified inefficiencies and implemented recommendations 208 may yield incremental improvements and/or modifications as the identified inefficiencies are addressed and new recommendations 208 are iteratively generated (block 206). In this manner, the hospital operations 284 (e.g., care processed, scheduling, staff planning, and so forth) may be optimized and maintained in an optimal or near optimal state over time. In this manner, the operating costs of the hospital may be reduced and service quality and patient satisfaction may be improved or maintained.

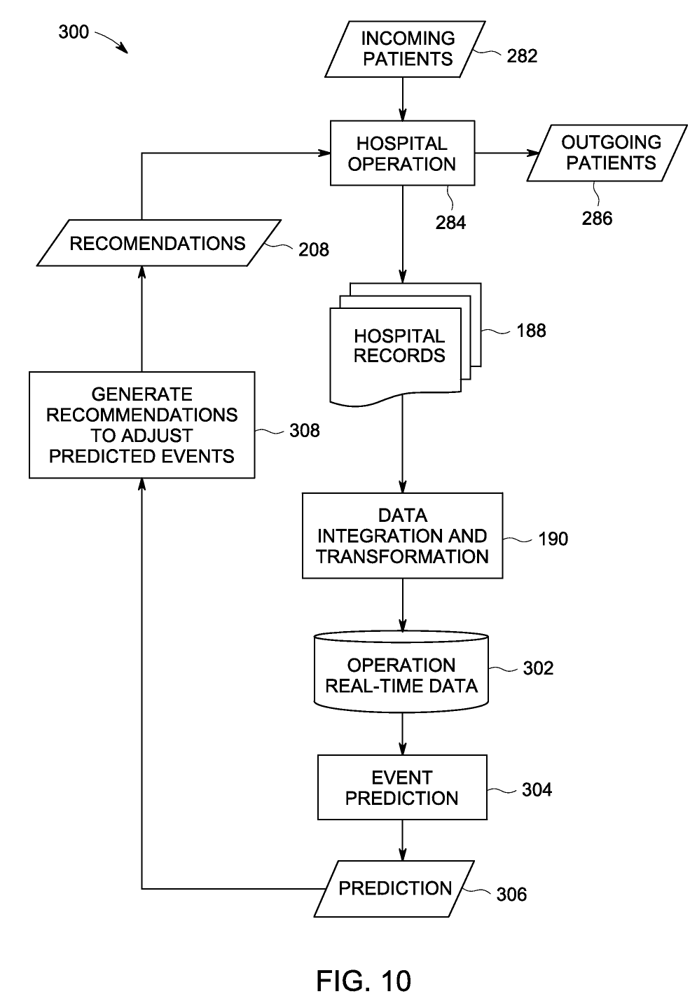

In addition, as noted above, an event prediction module 304 may be generated based on the various analyses of hospital operational data and/or root causes 204 discussed herein. Such an event prediction model 304 may be used to provide warning or near term or pending events and/or to make recommendations to avoid or mitigate such near-term or pending events. For example, turning to FIG. 10, a flowchart 300 depicts steps associated with one implementation of an event prediction module 304 as discussed herein. In accordance with this implementation, incoming patients 282 are taken in and treated as part of the hospital operation 284, eventually being released as outgoing patients 286. As will be appreciated, the hospital operation 284 may include the treatment and/or observation of the patient (i.e., patient care flow) as well as encompassing the scheduling and activity of medical staff, administrative personnel, equipment, facilities, and any other hospital resource or personnel. As a consequence of the operation of the hospital, various hospital records 188 are generated which may be integrated and/or assimilated (block 190) and stored as accessible real-time or near-time operational data 302 describing the current operating conditions of the hospital.

In one implementation, an event prediction module 304 accesses the operational data 302 and, based on the programming and/or training of the event prediction module, generates one or more predictions 306 as to events that may warrant special attention or consideration. The event prediction module 304 may generate predictions 306 based on current or estimated values for one or more features 196 of the operational data 302 where the respective features 196 have previously been determined to be associated with an undesired or inefficient event at the hospital (e.g., a root cause 204 of an undesired value of a key performance indicator 200). Based on the prediction 306, one or more corrective or responsive actions (i.e., recommendations 208) may be generated (block 308) and automatically implemented (such as by making a patient or personnel scheduling change and/or an equipment request) or provided to hospital personnel to mitigate or address the predicted event. Such recommendations may be hospital specific and may be based on the guidelines or rules prepared by the hospital which relate to the expected event. Alternately, if no recommendation 208 is available or feasible, the hospital personnel may simply be automatically notified of the pending event. For example, hospital space or staffing restrictions may limit the actions that may be taken to mitigate a predicted event.

By way of example, features 196 that are determined to be significant to a defined event (i.e., root causes 204 of the event) can be used to make a prediction of such event ahead of time. In one example an inpatient unit may be characterized by a set of state variables (features 196): occupancy, length of stay distribution, date of the week, and occupancy change at evening time window (e.g., 8 PM˜midnight). A prediction transformation function for this example may be generated or learned using a Classification and Regression Tree (CART) or similar analytic approach. Such a prediction function, once derived, may be used to predict the occurrence of certain events in the inpatient unit. For instance, in the present example, the derived prediction transformation function may be provided with values for the set of state variables used in the predictive model and, based on the values of these inputs, may provide an indication of whether the modeled event will occur or is likely to occur, such as will there be occupancy >80% in the next day. In this example, the event of interest such as an occupancy demand (e.g., a bed or room shortage) may be predicted (block 304) and a unit bed manager may be automatically notified prior to the occupancy demand. This notice may allow the bed manager to coordinate proper actions, such as expediting the discharge/transfer process, to mitigate a potential patient flow problem. Alternatively, one or more of these responses may be automated once the event is predicted (e.g., scheduling changes may be automatically made to expedite patient transfer or discharge). In this manner, the event prediction process can drive the short-term planning performed at the hospital, thereby improving short term performance.

While the long-term (i.e., operation modification) and short-term (i.e., event prediction) aspects have been discussed separately above, it should be appreciated that both short-term event prediction and long-term operation adjustment may be implemented together. In this manner the operation of a hospital may be continuously adjusted in a systematic manner to help the hospital continuously adjust the planning decision process, which in turn may reduce operation cost and improve service quality and patient satisfaction.

Technical effects of the invention include the use of computer-implemented processes, routines, and/or algorithms to analyze hospital records to identify deviations from normal operation (based on rule based criteria or statistical significance). An additional technical effect of the invention includes the use of computer-implemented processes, routines, and/or algorithms to determine root causes or contributing factors of identified deviations from normal operation. A further technical effect of the invention includes the use of computer-implemented processes, routines, and/or algorithms to make recommendations based on historical hospital operational data and/or predict events based on current hospital operational data. A further technical effect is the automated implementation of recommendations made by computer-implemented processes, routines, and/or algorithms based on historical hospital operational data and/or current hospital operational data.

This written description uses examples to disclose the invention, including the best mode, and also to enable any person skilled in the art to practice the invention, including making and using any devices or systems and performing any incorporated methods. It should be appreciated that aspects of the examples disclosed herein may be combined with aspects of other examples without deviating from the scope of the present invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for identifying and addressing operational deficiencies at a hospital, the method comprising:
accessing one or more databases comprising a plurality of hospital records;
extracting a plurality of features from the hospital records, wherein the features comprise metrics that summarize aspects of the hospital records at different times;
deriving a performance indicator that provides a measure of operational performance for the hospital, wherein the performance indicator comprises a metric that represents an aspect of the operational performance of the hospital at different times; and
identifying one or more root causes contributing to the derived performance indicator, wherein the one or more root causes comprise a feature or subset of features that contributes to the value of the performance indicator.

2. The method of claim 1, wherein the hospital records describe the flow of patients through the hospital.

3. The method of claim 1, wherein the hospital records comprise records describing the scheduling of availability of one or more of hospital staff, hospital facilities, or hospital equipment.

4. The method of claim 1, wherein the features characterize hospital operation states.

5. The method of claim 1, wherein the features each comprise a multivariate time series.

6. The method of claim 1, wherein the performance indicator characterizes hospital operation performance states.

7. The method of claim 1, wherein the performance indicator comprises a multivariate time series that characterizes hospital operation performance states.

8. The method of claim 1, comprising automatically implementing a recommendation generated based upon the one or more root causes.

9. The method of claim 1, wherein identifying the one or more root causes comprises:
identifying a first set of cases where the performance indicator is acceptable and a second set of cases where the performance indicator is not acceptable;
identifying a feature, a subset of features, or a transformation of one or more features that distinguish the first set of cases from the second set of cases.

10. One or more non-transitory computer-readable media, the computer-readable media comprising one or more routines which, when executed by a processor, perform acts comprising:
accessing a database comprising a plurality of hospital records wherein the hospital records comprise records describing the flow of patients through the hospital and records describing the scheduling of availability of one or more of hospital staff, hospital facilities, or hospital equipment;
extracting a plurality of features from the hospital records, wherein the features comprise metrics that summarize aspects of the hospital records at different times;
deriving a performance indicator that comprises a metric that represent an aspect of the operational performance of the hospital at different times; and
identifying one or more root causes that comprise a feature or subset of features that contributes to the value of the performance indicator.

11. The one or more non-transitory computer-readable media of claim 10, wherein the features each comprise a multivariate time series that characterizes hospital operation states.

12. The one or more non-transitory computer-readable media of claim 10, wherein the performance indicator comprises a multivariate time series that characterizes hospital operation performance states.

13. The one or more non-transitory computer-readable media of claim 10, wherein identifying the one or more root causes comprises:
identifying a first set of cases where the performance indicator is acceptable and a second set where the performance indicator is not acceptable;
identifying a feature, a subset of features, or a transformation of one or more features that distinguish the first set of cases from the second set of cases.

14. A method for generating recommendations or notifications for a hospital, the method comprising:
accessing one or more databases comprising a plurality of hospital records;
identifying an operational deficiency or predicting an event using one or more features derived from the plurality of hospital records; and
generating a recommendation based on the identified operational deficiency or the predicted event.

15. The method of claim 14, wherein the plurality of hospital records comprise current hospital records, features of which are used to predict the event.

16. The method of claim 14, wherein the plurality of hospital records comprise historical hospital records, features of which are used to identify the operational deficiency.

17. The method of claim 14, comprising adjusting the operation of the hospital based on the recommendation.

18. The method of claim 14, wherein the operational deficiency is identified or the event is predicted based on one or more features determined to be contributing factors to the operational deficiency or the event.

19. The method of claim 14, comprising automatically implementing the recommendation.

20. The method of claim 19, wherein automatically implementing the recommendation comprises one or more of automatically adjusting a personnel schedule, a patient processing schedule or sequence, a procedure schedule, or an equipment schedule.
